(19) United States
(12) Patent Application Publication
(10) Pub. No.: US 2019/0380308 A1
(43) Pub. Date: Dec. 19, 2019

(54) Animal Claw Shearing Apparatuses and Methods of Using the Same

(71) Applicant: Pet Product Innovations, LLC, Des Plaines, IL (US)

(72) Inventors: Michael J. Bihlmaier, Marengo, IL (US); Levi J. Perea, JR., Des Plaines, IL (US); David Levy, Des Plaines, IL (US)

(73) Assignee: Pet Product Innovations, LLC, Des Plaines, IL (US)

(21) Appl. No.: 16/542,641

(22) Filed: Aug. 16, 2019

Related U.S. Application Data
(63) Continuation of application No. 15/124,835, filed on Sep. 9, 2016, now abandoned.
(60) Provisional application No. 61/951,647, filed on Mar. 12, 2014.

(51) Int. Cl. A01K 17/00; A01K 13/00; A45D 29/02

(52) U.S. Cl. CPC A01K 17/00; A45D 29/02; A01K 13/00

(57) ABSTRACT

A claw shearing device including a pair of shearing elements having cutting edges that face one another, a fastener configured to pivotably attach the shearing elements, and an adjustable limiting mechanism connected to the pair of shearing elements. The cutting edges form an orifice for the insertion of a claw of an animal or a pet therebetween, where the maximum size of the orifice is limited by the adjustable limiting mechanism. The device is configured to bring together the shearing elements to cut the claw or nail of the animal or pet at a predetermined length.

This this application claims the benefit of priority from U.S. application Ser. No. 15/124,835, filed Sep. 9, 2016, which claims the benefit of priority from PCT Application US2015/020302, filed on Mar. 15, 2015, which claims the benefit of priority from U.S. provisional Application Ser. No. 61/951,647, filed Mar. 12, 2014, the entirety of each which is incorporated herein by reference.

### FIELD OF THE INVENTION

The present disclosure generally relates to grooming and shearing devices for animals, such as pets. More specifically, the present disclosure is related to claw and/or nail shearing devices which can be used to shear, cut and/or trim the nails and/or claws of animals, such as pets.

### BACKGROUND

Most animals and pets do not enjoy having their nails and/or claws sheared or cut. The nails of animals and pets, such as those of dogs, cats, rabbits, and other mammals contain a hard outer shell and a soft cuticle located toward the center of the nail. The cuticle is often referred to as the “quick” or “kwick” of the pet's nail (hereinafter “quick”). The cuticle or quick contains a nerve and a blood vessel. Accidentally cutting the quick of the nail can cause excessive bleeding and varying sensations of pain, trauma, and severe discomfort for the animal. Unfortunately, it is not uncommon for even the most seasoned pet owner to accidentally or inadvertently cut the quick of the pet's nail, thereby causing bleeding, pain, and sometimes severe trauma for the pet. Although pet owners can attempt to rely on experienced professionals to cut their pet's nails, even this approach does not eliminate human error and the possibility of cutting the quick.

### SUMMARY

The present invention relates to devices for shearing or cutting the nails and/or claws of animals, and methods for using same. As used herein, it will be appreciated that the term “shearing” can be used interchangeably with the terms “trimming” and “cutting,” particularly with reference to an animal's nails and/or claws. The terms “shearing,” “cutting” and “trimming” will be understood herein to refer to an act of breaking off or causing to break off a portion of the object being sheared, cut, and/or trimmed (such as the nails and/or claws of an animal).

As used herein, it will be understood by one of ordinary skill that the terms “claw” and “nail,” in relation to the claws and nails of an animal, such as a pet, can be used interchangeably.

According to an embodiment of the present invention, a claw shearing device is provided including a first shearing element and a second shearing element. Both the first and the second shearing elements include a cutting edge, a connecting portion, and a handle portion. In both the first and the second shearing elements, the handle portion is distal in relation to the connecting portion, and the cutting edge is proximate in relation to the connecting portion. The claw shearing device also includes a fastener and an adjustable limiting mechanism. The fastener is configured to pivotably attach the connecting portion of the first shearing element to the connecting portion of the second shearing element such that the cutting edge of the first shearing element and the cutting edge of the second shearing element are facing each other. The cutting edges are also configured to form an orifice for the insertion of a claw of a pet or an animal therebetween. The claw shearing device is configured to bring together the first and the second shearing elements to cut the claw of the pet at a predetermined length, where the size of the orifice is limited by the adjustable limiting mechanism.

According to another embodiment of the present invention, a method is provided of using a device for shearing an animal's claw. The method includes providing a claw shearing device having a first shearing element, a second shearing element, a fastener, and an adjustable limiting mechanism. The first shearing element and the second shearing element each include a cutting edge and a handle portion. The fastener is configured to pivotably attach the first shearing element to the second shearing element, such that the cutting edges are facing each other. The cutting edges also form an orifice for the insertion of the animal's claw. The device is configured such that a size of the orifice is limited by the adjustable limiting mechanism. The method also includes determining a maximum diameter of the animal's claw as measured from a tip of the claw to the beginning of the quick of the animal that is closest to the tip. The limiting mechanism is adjusted such that a maximum diameter of the orifice is less than the above-determined maximum diameter. The animal's claw is inserted into the orifice of the device, and the animal's claw is sheared by bringing together the shearing elements of the device.

According to any one of the above embodiments of the present invention, at least one of the first cutting edge and the second cutting edge can be a convex curved cutting edge. According to any one of the above embodiments of the present invention, one of cutting edges can be a convex curved cutting edge, and the second cutting edge can be a substantially flat cutting edge.

According to any one of the above embodiments, the orifice can be elliptical or round in shape.

According to any one of the above embodiments, the orifice can be diamond-like in shape.

According to any one of the above embodiments, the cutting edges are cut at an inclined angle and positioned such that the facing cutting edges create a funnel-like shape tapering in the direction of the claw or nail as the claw or nail is inserted into the orifice of the device.

According to still another embodiment, claw shearing device is provided having a first shearing element comprising a cutting edge having an offset V shape. A second shearing element includes a cutting edge having an offset V shape. The first and second shearing elements are pivotably interconnected to form an orifice for the insertion of a claw of a pet therebetween. The cutting edges engage the claw in at least four points evenly spaced along the circumference of the claw and therefore cleanly shear the claw without twisting or torsion.

As used herein “substantially”, “relatively”, “generally”, “about”, and “approximately” are relative modifiers intended to indicate permissible variation from the characteristic so modified. They are not intended to be limited to the absolute value or characteristic which it modifies but rather approaching or approximating such a physical or functional characteristic.

In this detailed description, references to “one embodiment”, “an embodiment”, or “in embodiments” mean that the feature being referred to is included in at least one embodiment of the invention. Moreover, separate references to “one embodiment”, “an embodiment”, or “embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

### BRIEF DESCRIPTION OF THE SEVERAL VIEWS OF THE DRAWINGS

FIG. 1 is an illustration of a claw shearing device according to one embodiment of the present invention.

FIG. 2 is a close-up illustration of the cutting edge portions of a device in a partially open position according to another embodiment of the present invention.

FIG. 3 is an illustration of a claw shearing device according to another embodiment of the present invention.

FIG. 4 is an illustration of a claw shearing device according to another embodiment of the present invention.

FIG. 5 is an illustration of a claw shearing device according to another embodiment of the present invention.

FIG. 6 is an illustration of a claw shearing device according to another embodiment of the present invention.

FIG. 7 is an illustration of a claw shearing device according to another embodiment of the present invention.

FIG. 8 is an illustration of a claw shearing device according to another embodiment of the present invention.

FIG. 9 is an illustration of a claw shearing device according to another embodiment of the present invention.

FIG. 10 is an illustration of a claw shearing device according to another embodiment of the present invention.

FIG. 11 is an illustration of a single blade having a shearing arc R.

Given the following enabling description of the drawings, the devices and methods should become evident to a person of ordinary skill in the art.

### DETAILED DESCRIPTION

According to the devices of the present invention, it is possible to shear, cut or trim an animal or a pet's claws or nails without cutting the quick. Devices of the present disclosure include shearing elements having cutting edges, which are configured to face each other and create an orifice for the insertion of an animal's (or pet's) claw. Devices of the present disclosure also include an adjustable mechanism which makes it capable to adjust the maximum diameter size opening of the orifice such that the portion of the animal's claw that can be inserted into the orifice does not include any portion of the quick. This substantially reduces, and in some instances eliminates altogether, the possibility of cutting the quick of the animal's claw while shearing the claw. Methods of using devices of the present invention are also described herein.

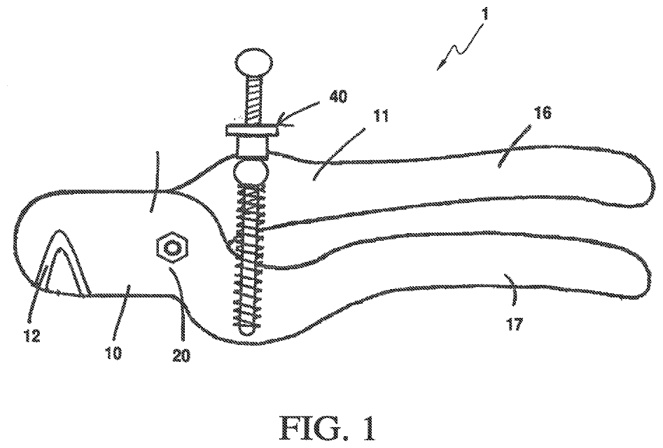

With reference now to FIG. 1, a claw shearing device 1 is illustrated. The claw shearing device 1 of FIG. 1 is shown in a closed position. The claw shearing device includes a first shearing element 10 and a second shearing element 11. The first shearing element 10 can include a cutting edge 12, a connecting portion 14, and a handle portion 16. The second shearing element 11 can also include a cutting edge and a connecting portion (not illustrated) and a handle portion 17.

The configuration of the shearing elements is not particularly limited. For example, the shearing elements can be configured to resemble a scissor style claw shearing device. Alternatively, the shearing elements can be configured to resemble a guillotine style claw shearing device, a shear style claw shearing device, and/or a plier style claw shearing device. Moreover, regardless of whether the shearing device of the present invention is configured to resemble a scissor style, a guillotine style, a shear style and/or a plier style shearing device, it will be appreciated that the relative size of the shearing device can be modified to a small, medium, and/or large device (e.g., a small scissor-style shearing device, a medium guillotine-style shearing device, and the like).

In some embodiments, the handle portion can include a gripping layer (not illustrated) covering or surrounding the handle portion.

In embodiments, the gripping layer can be made of any resilient, durable and non-toxic rubber or plastic material, such as natural and synthetic rubbers or a blend of synthetic rubbers, nylons, polyesters, and vinyl plastics. In embodiments, illustrative examples of suitable materials that the first and second portions can be made of include, but are not limited to, neoprene plastic, isoprene, styrene-butadiene rubber, butadiene, ethylene-propylene, butyl, chloroprene, nitrile rubber, polyurethane, polycarbonate, acrylonitrile butadiene styrene, and mixtures thereof.

As shown in FIG. 1, the handle portion 16 of the first shearing element 10 is distal in relation to the connecting portion 14, and the cutting edge 12 of the first shearing element 10 is proximal in relation to the connecting portion 14. The same can be said for the connecting portion, the cutting edge, and the handle portion 17 of the second shearing element 11.

The device 10 can also include a fastener 20. The fastener 20 can be configured to pivotably attach the connecting portion 14 of the first shearing element 10 to the connecting portion of the second shearing element 11. Suitable fasteners 20 include, but are not limited to, nuts and bolts, screws, and/or rivets. The fastener 20 is configured to attach the connecting portions of the first and second shearing elements 10, 11 such that the cutting edge 12 of the first shearing element 10 and the cutting edge of the second shearing element 11 are facing each other.

In embodiments, shearing elements 10, 11 are configured to form an orifice for the insertion of a claw or a nail of a pet therebetween. For example, the device 1 can be configured to bring together the shearing elements 10, 11 to shear or cut the claw or nail of a pet at a predetermined length. During operation, a user can hold the handle portions of the shearing elements to operate the device.

In embodiments, the cutting edge can be replaceable as needed, or be permanently affixed to, or integrally formed with the device.

In some embodiments, at least one of the cutting edges can be a curved edge. In some embodiments, the first cutting edge 12 or the second cutting edge can be a curved edge, and the other cutting edge can be a substantially flat edge surface. In some embodiments, both the first cutting edge 12 and the second cutting edge can be a convex curved edge, configured such that the cutting edges form a convex, converged orifice during operation of the device.

The shape of the orifice is not particularly limiting. In some embodiments, the shape of the orifice can be elliptical or round-like in shape, such as in a circular shape. In other embodiments, the orifice can be a diamond or other polygonal shape.

In some embodiments, the cutting edges form an inclined angle and are positioned such that the facing cutting edges create a funnel-like shape tapering in the direction of the claw as the claw of the animal is inserted into the orifice of the device.

In embodiments, the cutting edges are capable of producing a substantially smooth cut claw edge in a single cutting action, with very little to no twisting action or twisting effort required by the user. As such, in embodiments the user is capable of achieving a substantially smooth cut claw edge in a single cutting action simply by an act of bringing the two shearing elements together to close the orifice around the inserted claw.

Device embodiments of the present disclosure also include an adjustable limiting mechanism. The adjustable limiting mechanism can be connected to the first shearing element and the second shearing element. The adjustable limiting mechanism can be configured such that the maximum diameter and size of the orifice is limited by the adjustable limiting mechanism.

Suitable adjustable limiting mechanisms include, but are not limited to, a combination of a thumb wheel on a threaded rod. In embodiments, the adjustable limiting mechanism can also include a thumb screw or a nautilus or a cam shaped wheel mounted between the first and the second shearing elements. In other embodiments, the adjustable limiting mechanism can include a telescoping device.

With regard to a telescoping adjustable limiting mechanism, in embodiments, the telescoping adjustable limiting mechanism may have a plurality of through holes or through-openings, of various shapes and sizes and positioned at various locations along the length of the adjustable limiting mechanism. Each through hole represents a different length of adjustment, and therefore corresponds to a different size opening for the orifice of the device.

Generally, the diameter of the claw of an animal increases from the tip of the claw, as one approaches the beginning of the quick that is closest to the tip, and continuing in a direction toward the animal. The diameter of the claw of an animal is smallest when measured at the tip of the claw, at a point furthest away from the animal itself.

During use, the maximum diameter of an animal's claw along the length of the claw beginning at the tip of the animal's claw (furthest from the animal itself) to an endpoint of the quick of the animal's claw that is located closest to the tip of the claw is determined. Then, the adjustable limiting mechanism is engaged to set the maximum diameter and size of the orifice to be less than the above-determined maximum diameter. During use, the animal's claw is inserted into the orifice of the device. Because the maximum diameter and size of the orifice has been set to be less than the maximum diameter of the animal's claw that is measured from the length of the claw between the tip of the claw to the quick of the animal's claw that is closest to the claw tip, shearing or cutting the animal's claw by use of the device will not cut the quick of the animal.

Referring back to FIG. 1, device 1 of the present disclosure can also include a shaft 40. The shaft 40 can be configured to extend between, and be releasably connected to, at least one of the first shearing element 10 and the second shearing element 11, such that the cutting edges of the shearing elements 10, 11 are facing each other.

In embodiments, one or both opposite ends of the shaft 40 may be threaded. One or both of the first and the second shearing elements 10, 11 can also contain a threaded opening such that one or both of the first and second shearing elements are releasably connectable to one or both ends of the shaft 40. The threaded opening extends at least partially through the total thickness of the first and/or second shearing element. The threaded opening may also extend through the entire thickness of the first and/or second shearing element.

For example, in some embodiments, at least one of the first shearing element 10 and the second shearing element 11 can include a threaded center opening, such that the at least one threaded center opening is capable of releasably engaging with a threaded portion of the shaft.

In embodiments, the shaft 40 may also contain a shoulder. In embodiments, the shaft screw thread advances until the shoulder butts against a bottom surface of the threaded portion of the shearing element. Alternatively, the shaft 40 may create a threaded or unthreaded friction fit with a threaded or unthreaded hole in the shearing element, which preferably permits adjustment and retention of an exposed length of the shaft 40.

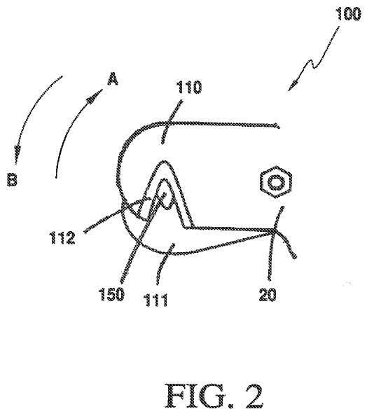

With reference to FIG. 2, a close-up illustration of the cutting edge portions of a shearing device 100 in a partially open position is provided. The device 100 includes a fastener 120 that interconnects shearing elements 110 and 111.

Portions of a first shearing element 110 and a second shearing element 111 are shown in FIG. 2. The cutting edge 112 of the first shearing element 110 and the cutting edge of the second shearing element 111 are partially spread apart from one another to form an orifice 150. The shearing elements are opened in the direction of arrow A. The orifice 150 in FIG. 2 is in the shape of a diamond, though any of the shapes, as described above, would also be suitable (e.g., elliptical, round, polygonal, etc.).

The maximum diameter or opening size of the orifice is limited, as described above, by an adjustable limiting mechanism or a shaft, and the like. Therefore, the maximum amount of direction that the shearing elements can be moved in the direction shown by arrow A is limited by the adjustment of the limiting mechanism. This is so that the maximum diameter or opening size of the orifice can be smaller than the maximum diameter of the claw of the animal as measured from the tip of the claw to the beginning of the quick closest to the tip of the claw.

During use, the claw or nail of an animal is inserted into the orifice 150. The maximum diameter or size of the orifice is limited, as described above, by an adjustable limiting mechanism or a shaft, and the like.

Once the claw of the animal is inserted, the shearing elements of the device are moved in the direction of arrow B to perform a cutting or a shearing action. The cutting edges of the shearing elements shear, cut, or pass through the claw of the animal, thereby shearing the claw at the desired length.

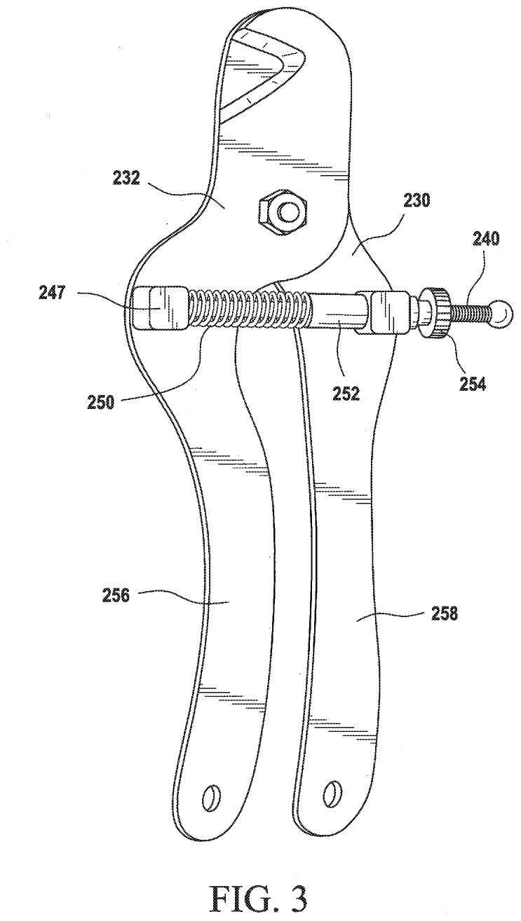

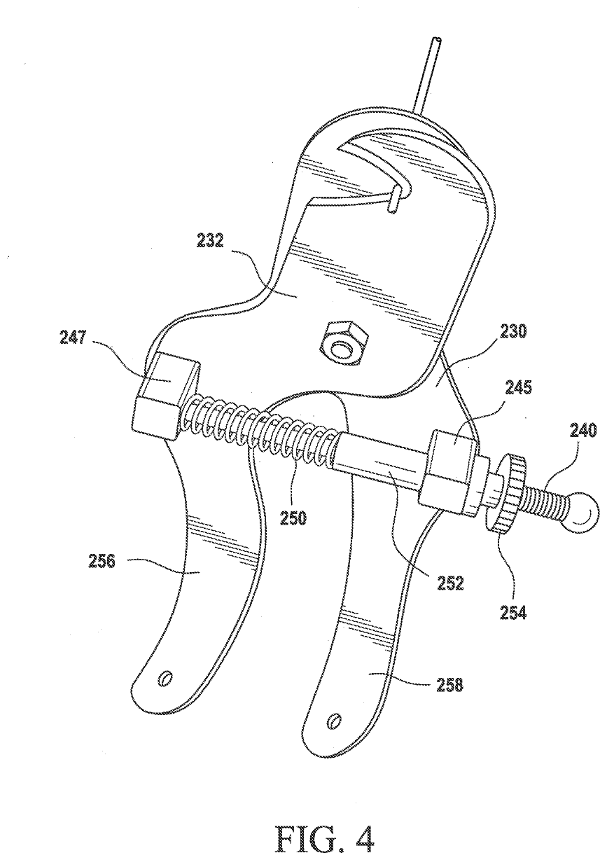

FIGS. 3-4 illustrate an embodiment of the adjustable claw shearing device of the invention. As illustrated, the adjustable limiting mechanism of this embodiment comprises shaft 240 which freely passes through guide 245 and is fixedly attached to stop 247. Guide 245 may be pivotally attached to shearing element 230 and stop 247 may be pivotally attached to shearing element 232. Spring 250 surrounds shaft 240 and abuts collar 252 at one end and abuts stop 247 at a second end. Collar 252 surrounds shaft 240 and abuts spring 250 at one end and abuts guide 245 at the other end. Shaft 240 is threaded and adjustment knob 254 is coupled to shaft 240. Spring 250 is biased towards block 245 and stop 247 to urge handles 256 and 258 away from each other thus opening the cutting blades. Shaft 240 is threaded and provided with an adjustment knob 254 which may be positioned along shaft 240 to control the maximum diameter or size of the orifice.

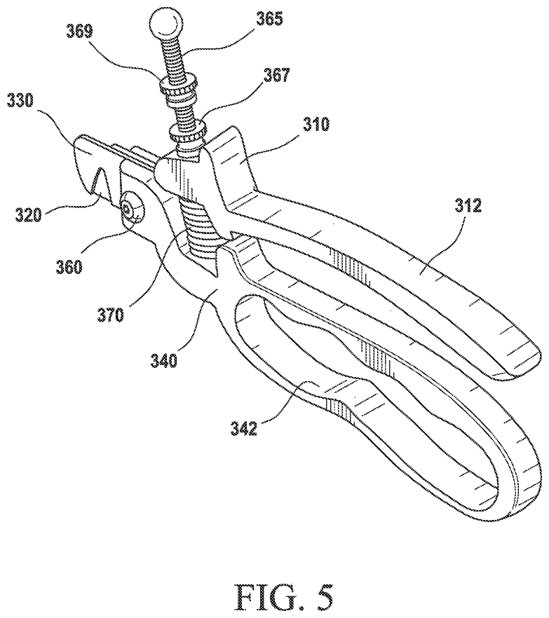

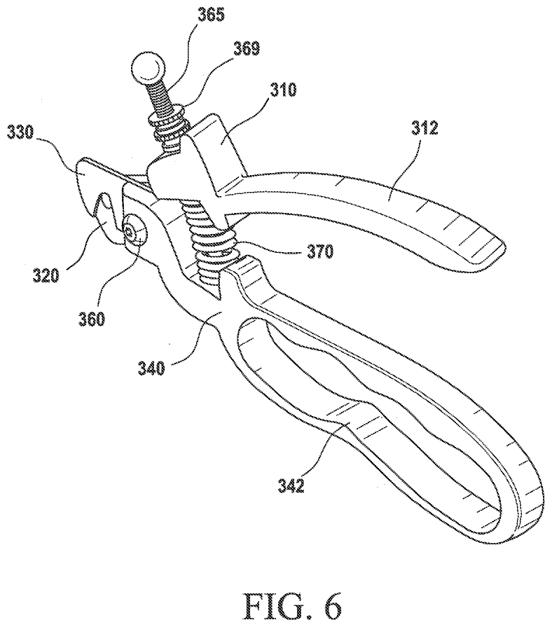

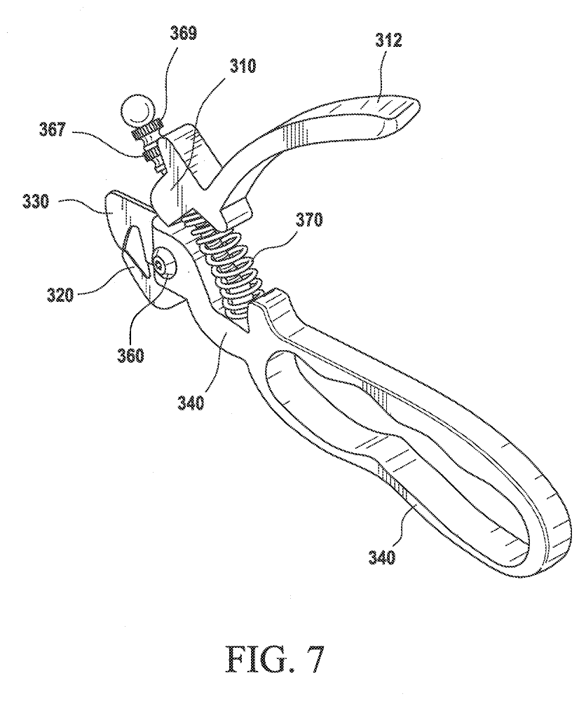

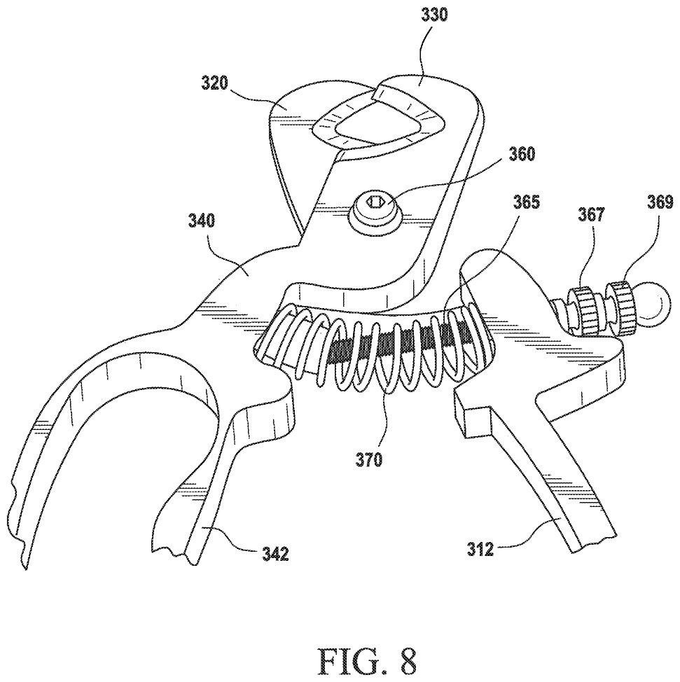

FIGS. 5 to 8 illustrate another embodiment of the adjustable claw shearing device of the invention in its closed, partially open and fully open state. In this embodiment the claw shearing device includes, first shearing element 310, first and second blades 320 and 330 and a second shearing element 340. First shearing element 310 includes a handle 312 and a connection portion 314. Second shearing element 340 includes a handle 342 and a connection portion 344. A fastener 360 is provided to pivotally interconnect first and second shearing elements and first and second blades 320 and 330 such that first blade 320 moves with first shearing element 310 and second blade 330 moves with second shearing element 340. Suitable fasteners include but are not limited to nuts, bolts, screws and/or rivets. In this embodiment, first and second blades 320 and 330 may be removed and replaced at the user's discretion. Alternatively, first and second blades 320 and 330 may be integrally formed with first and second shearing elements 310 and 340, respectively.

To control the maximum diameter or the size of the opening between first and second blades 320 and 330, a shaft 365 is passed through first shearing element 310 and fixedly attached to second shearing element 340. Spring 370 surrounds a portion of shaft 365 and is disposed between and abuts first and second shearing elements 310 and 340. Spring 370 is biased to urge first and second shearing elements 310 and 340 away from each other thereby urging blades 320 and 330 away from each other and creating an orifice between blades 320 and 330. Shaft 365 is provided with an adjustment knob 367 which is engaged with the threaded portion of shaft 365. As adjustment knob 367 is moved toward the end of shaft 365, spring 370 urges shearing elements 310 and 340 farther away from each other thereby enlarging the orifice between blades 320 and 330. A jam nut 369 is provided to lock the size of the orifice. This feature is particularly useful when a user has determined the optimal orifice size for his or her pet thereby allowing the user to reuse the device without having to recalibrate. Alternatively, adjustment knob 367 and jam nut 369 may be replaced by a thumb adjusting screw (not shown) such as that found in a conventional adjustable wrench. The thumb adjusting screw may be embedded in shearing element 310 and coupled to shaft 367 to facilitate quick and easy adjustment.

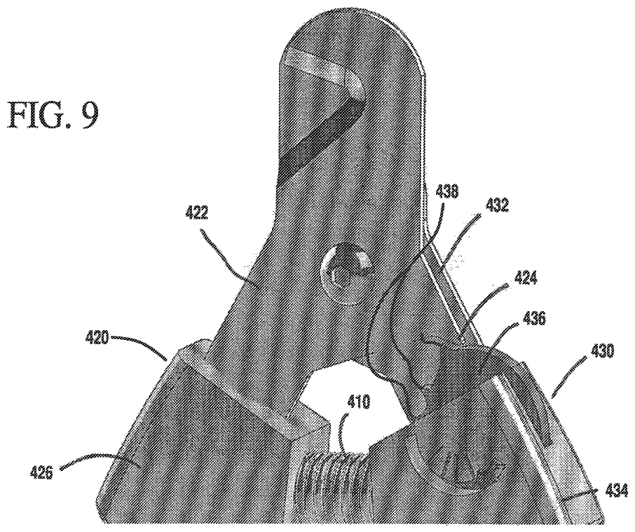

In still another embodiment of the invention illustrated in FIG. 9, the adjustable limiting mechanism may comprise a spring 410 fixedly attached to first and second shearing elements 420 and 430. First shearing element 420 includes a blade assembly 422 having a stop 424 and a handle 426 extending from blade assembly 420. Second shearing element 430 includes a blade assembly 432 and a handle 434 extending from blade assembly 432. To set and hold a maximum opening of blade assemblies, a cam 436 having a plurality of catches 438 is rotatably mounted within handle 426. Cam 436 may be rotated to allow different ones of catches 438 to engage stop 424. Each position in which a catch 438 engages stop 424 represents a different maximum opening of blade assemblies 420 and 430. Alternatively, cam 436 could be replaced by a thumb adjusting screw (not shown) such as that found in a conventional adjustable wrench. The thumb adjusting screw may be embedded in handle 426 and coupled to a shaft passing through spring 410 to facilitate quick and easy adjustment.

Also provided are methods for cutting or trimming the nails and/or claws of a pet utilizing nail cutting devices of the present disclosure. The maximum diameter of an animal's claw measured along the length of the claw from the tip of the animal's claw (furthest from the animal itself) to the end of the quick of the animal's claw that is closest to the tip is determined.

Then, the adjustable limiting mechanism is engaged to set the maximum diameter and size of the orifice to be less than the above-determined maximum diameter. During use, the animal's claw is inserted into the orifice of the device. Because the maximum diameter and size of the orifice has been set to be less than the maximum diameter of the animal's claw that is measured from the length of the claw between the tip of the claw to the quick of the animal's claw that is closest to the claw tip, shearing or cutting the animal's claw by use of the device will not cut the quick of the animal. The maximum diameter can be adjusted using the limiting mechanism or shaft of the nail cutting device, as described above.

By allowing only a portion of the pet's nail to enter the orifice that is less than the maximum diameter of the claw as measured from the tip of the claw to the beginning of the quick that is closest to the tip, this prevents the user of the nail cutting device from cutting the quick of the pet during use. The likelihood of the pet's quick getting cut while trimming or cutting the pet's nails is greatly decreased, thereby preventing injury, pain, trauma and/or bleeding. In certain instances, by using devices of the present disclosure, the likelihood of the pet's quick getting cut while trimming or cutting the pet's nails is effectively eliminated.

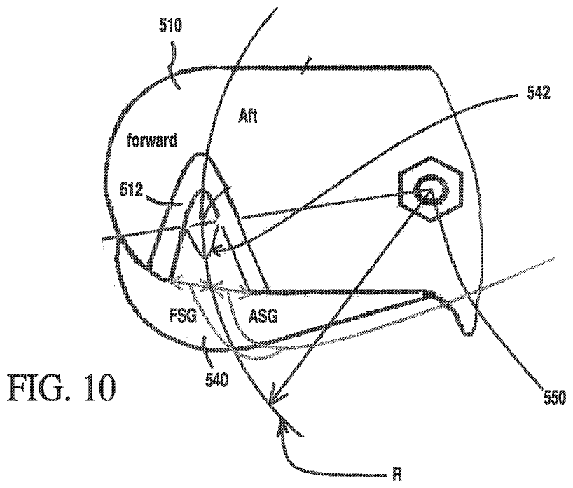

In keeping with the invention, various blade assemblies may be employed. However, in accordance with an aspect of the invention, a specific blade assembly was developed that is useable with all animal nail clippers, regardless of style or other functional attributes. As illustrated in FIG. 10 the blade assembly of the invention includes first and second blades 510 and 540 that are pivotally coupled to each other at pivot point 550. The first blade 510 includes a cutting edge 512 in the shape of an offset V and the second blade 540 includes a substantially identical shaped cutting edge. In some embodiments first and second blades 510 and 515 are interconnected in back to back fashion such that the vertices of the respective cutting edges oppose each other and an orifice or opening 542 is formed between first and second blades 510 and 540.

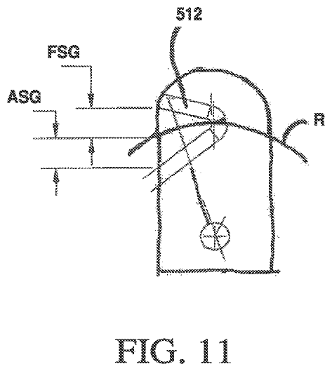

FIG. 11 shows a single blade having a shearing arc R. The shearing arc is the arc of the path that is traversed by the blade as the blade is opened and closed. As illustrated, shearing arc R bisects the vertex of cutting edge 512 and extends to the mouth of cutting edge 512. In accordance with a feature of the invention, at every point along the shearing arc R, the distance between the first leg of the offset V and the shearing arc, the forward shearing gap (FSG), is substantially equal to the distance between the second leg of the offset V and the shearing arc, the aft shearing gap (ASG). Accordingly, when an animal's claw is inserted into orifice 542 and the blade assembly is closed, the cutting edges engage the claw in at least four (4) points evenly spaced along the circumference of the claw thereby shearing the claw cleanly with a minimal amount of twist or torsion.

Embodiments of the present disclosure are suitable for use by canines, canids, felines, felids, ursidae, mustelidae, and procyonidae, or any other animal.

As used herein, “pet” refers to an animal that is tamed or domesticated and kept for pleasure as a companion, or as a work or service animal (e.g., guide dogs and police dogs). Illustrative examples of suitable pets include pet breeds that have nails and/or claws.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of at least one other feature, integer, step, operation, element, component, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It will also be appreciated that various presently unforeseen or unanticipated alternatives, modifications, variations or improvements therein may be subsequently made by those skilled in the art, and are also intended to be encompassed by the following claims.

What is claimed is:

1. A claw shearing device for a pet, comprising:
a first shearing element having a first cutting edge, a first connecting portion, and a first handle portion, wherein the first handle portion is distal in relation to the first connecting portion, and the first cutting edge is proximate in relation to the first connecting portion;
a second shearing element having a second cutting edge, a second connecting portion, and a second handle portion, wherein the second handle portion is distal in relation to the second connecting portion, and the second cutting edge is proximate in relation to the second connecting portion;
a fastener configured to pivotably attach the first connecting portion to the second connecting portion such that the first cutting edge and the second cutting edge are facing each other; and
an adjustable limiting mechanism connecting the first shearing element and the second shearing element via a shaft, wherein the cutting edges are configured to form an orifice for insertion of a claw of a pet therebetween,
wherein
the first cutting edge includes first and second opposing blades defined by a bisection of the vertex of the first cutting edge, and
a length of the first blade is longer than a length of the second blade.

2. The claw shearing device of claim 1, wherein the adjustable limiting mechanism includes
a spring disposed between and fixedly attached to said first and second shearing elements, and
a cam rotatably mounted in the first handle portion of said first shearing element, the cam including a plurality of catches,
wherein the connecting portion of said first shearing element includes a stop configured to engage one of the plurality of catches.

3. The claw shearing device of claim 1, wherein the first cutting edge has a V shape and the second cutting edge has an inverted V shape opposite the first cutting edge, the v-shaped cutting edges having vertices that oppose each other to form an orifice.

4. The claw shearing device of claim 3, wherein
each cutting edge forms a forward shearing gap and an aft shearing gap, and
the forward and aft shearing gaps are substantially equal at each point along a shearing arc formed by the bisection of the vertex of each cutting edge.

5. The claw shearing device of claim 4, wherein the first cutting edge is a curved edge and the second cutting edge is a curved edge configured such that the cutting edges form a convex, converged orifice during operation of the device.

6. The claw shearing device of claim 4, wherein
the second cutting edge includes first and second opposing blades defined by the bisection of the vertex of the second cutting edge, and
a length of the first blade of the second cutting edge is longer than a length of the second blade of the second cutting edge.

7. The claw shearing device of claim 6, wherein the first blade of the second cutting edge is closer to the fastener than the second blade of the second cutting edge.

8. A claw shearing device for a pet comprising:
a first shearing element comprising a first cutting edge having a V shape, a first connecting portion, and a first handle portion;
a second shearing element comprising a second cutting edge having an inverted V shape opposite the first cutting edge, a second connecting portion, and a second handle portion;
a fastener configured to pivotably attach the first connecting portion to the second connecting portion; and
an adjustable limiting mechanism including
a spring disposed between and fixedly attached to said first and second shearing elements, and
a cam rotatably mounted in the first handle portion of said first shearing element, the cam including a plurality of catches,
wherein
the v-shaped cutting edges are configured to form an orifice for insertion of a claw of a pet therebetween,
the v-shaped cutting edges are configured to engage the claw at at least four points evenly spaced along a circumference of the claw,
the v-shaped first cutting edge includes first and second opposing blades defined by a bisection of the vertex of the v-shaped first cutting edge, and
a length of the first blade is longer than a length of the second blade.

9. The claw shearing device of claim 8, wherein the connecting portion of said first shearing element includes a stop configured to engage one of the plurality of catches.

10. The claw shearing device of any of claim 8, wherein the v-shaped first cutting edge and the v-shaped second cutting edge have vertices that oppose each other.

11. The claw shearing device of claim 8, wherein
each cutting edge forms a forward shearing gap and an aft shearing gap, and
the forward and aft shearing gaps are substantially equal at each point along a shearing arc formed by the bisection of the vertex of each cutting edge.

12. The claw shearing device of claim 11, wherein
the v-shaped second cutting edge includes first and second opposing blades defined by the bisection of the vertex of the v-shaped second cutting edge, and
a length of the first blade of the second cutting edge is longer than a length of the second blade of the second cutting edge.

13. The claw shearing device of claim 12, wherein the first blade of the second cutting edge is closer to the fastener than the second blade of the second cutting edge.

14. A method of using a device for shearing an animal's claw, the method comprising:
providing a claw shearing device having a first shearing element, a second shearing element, a fastener, and an adjustable limiting mechanism, the first shearing element and the second shearing element each having a cutting edge and a handle portion, wherein the fastener is configured to pivotably attach the first shearing element to the second shearing element such that the cutting edges are facing each other, the cutting edges forming an orifice for the insertion of the animal's claw, and the device being configured such that a size of the orifice is limited by the adjustable limiting mechanism;
determining a maximum diameter of the animal's claw as measured from a tip of the claw to the beginning of a quick that is closest to the tip;
adjusting the limiting mechanism such that a maximum diameter of the orifice is less than the determined maximum diameter;
inserting the animal's claw into the orifice of the device; and
shearing the animal's claw by bringing together the shearing elements of the device via the handle portions.

15. The method of claim 11, wherein the shearing step always eliminates the orifice.
